(19) United States
(12) Patent Application Publication
(10) Pub. No.: US 2016/0299656 A1
(43) Pub. Date: Oct. 13, 2016

(54) SYSTEM AND METHOD FOR SAVING AN OPEN FILE

(71) Applicant: Thomas M. ISAACSON, Huntingtown, MD (US)

(72) Inventor: Thomas M. ISAACSON, Huntingtown, MD (US)

(21) Appl. No.: 14/681,205

(22) Filed: Apr. 8, 2015

(51) Int. Cl. G06F 3/0486; G06F 3/0484; G06F 17/30; G06F 3/0481

(52) U.S. Cl. CPC G06F 3/0486; G06F 3/04817; G06F 3/04842; G06F 17/30126; G06F 17/30076

(57) ABSTRACT

Disclosed herein are systems, methods, and non-transitory computer-readable storage media for saving an open file to an open destination on a graphical display using a drag and drop method. The system presents an action icon associated with an open file such that the action icon is selectable by a user. The system receives an interaction from the user with the icon, such as via a computer mouse click. Following a dragging indication by the user, the dragging indication being associated with the interaction and resulting in a destination for the file identifiable on a graphical display, the system saves the open file at the destination.

### BACKGROUND

1. Technical Field

The present disclosure relates to file saving and more specifically to saving an open file on a desktop using a drag and drop method.

2. Introduction

When a computer user is using a word processing or other computer program, the user periodically will save an open file. The first time a user saves a file, the user must navigate to a desired folder for saving using a dialog box from within the computer program. Computer users regularly have multiple windows open at the same time on their desktops to avoid continually having to navigate to a frequently used folder. It is inconvenient and time consuming for users to navigate to a desired folder using a dialog box within a computer program when the desired folder is already open on the desktop.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for saving an open file on a computer desktop. A system can present an action icon associated with an open file, such that the action icon is selectable by a user. The system can receive an interaction from the user with the icon, such as clicking on the icon using a mouse or tapping the icon using a finger on a touch screen. Next, the system can follow a dragging indication by the user, the dragging indication being associated with the interaction and resulting in a destination for the file identifiable on a graphical display. Then the system can save the open file at the destination. The destination can be one of an open folder on the graphical display, a desktop of the graphical display, an open email and a post on a social networking application. The destination can be one of a local storage drive and a network storage drive.

Additionally, the system can present a second action icon associated with the open file, such that the action icon is associated with saving a first version of the open file at the destination and the second action icon is associated with saving a second version of the open file at the destination. The first version is an unedited version of the open file and the second version of the open file is an edited version of the open file.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates a screenshot including an action icon for file saving;

FIG. 3 illustrates a screenshot of a customizable icon grouping for file saving;

FIG. 4 illustrates a screenshot of an email application and a spreadsheet; and

FIG. 5 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

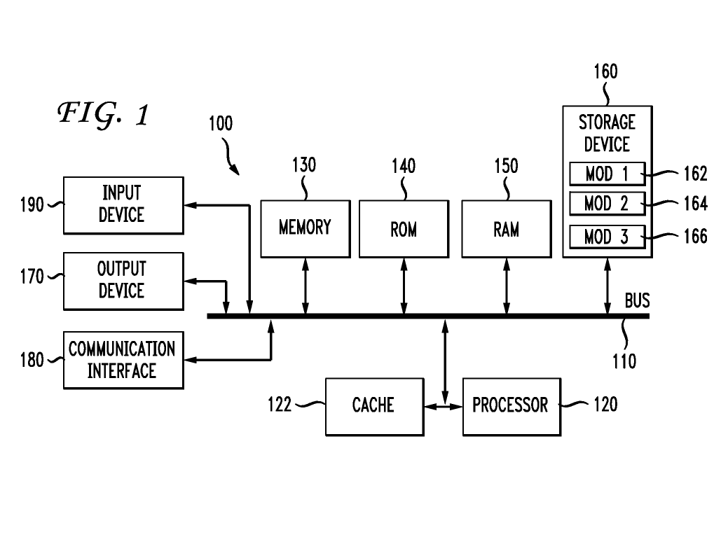

The present disclosure addresses the need in the art for more efficient file saving. A system, method and non-transitory computer-readable media are disclosed which save an open file using a drag and drop method instead of the traditional method of navigating to a desired folder using a dialog box within a computer program. A brief introductory description of a basic general purpose system or computing device in FIG. 1 which can be employed to practice the concepts is disclosed herein. A more detailed description of saving an open file using a drag and drop method will then follow.

Computer users often send files to other users for review via an email attachment. When a computer user opens an email attachment containing a file, a computer program opens that can allow the user to view and/or edit the file. However, the user must navigate using a dialog box within the computer program to a desired folder for saving. This is the case even when the desired folder is open on a desktop in another window. It is inconvenient and time-consuming for computer users to navigate to a folder for file saving when the desired folder is already open on the computer desktop. For example, Alice sends Bob a text document for review that Bob will return to Alice after he reviews the document. Bob receives the document as an email attachment and opens the attachment. A text editing program opens and displays the email attachment. Bob edits the email attachment within the text editing program and saves the edited version using the traditional method of clicking on a save icon within the program and navigating to the desired folder for saving. However, Bob has several other windows open on his computer desktop, including a window with the desired folder for saving.

A method is presented that enables a computer user, such as Bob, to avoid navigating to a desired folder or destination when the desired destination is open in a window on a computer desktop. A system can present an action icon associated with an open file such that the action icon is selectable by a user. The system can receive an interaction from the user with the icon such as by clicking on the icon with a computer mouse or by tapping on the icon using a finger on a touch screen. Following a dragging indication by the user, the dragging indication being associated with the interaction and resulting in a destination for the file identifiable on a graphical display the system can save the open file at the destination. Instead of the traditional method of navigating to a desired folder for saving through an open computer program, Bob can click on an action icon from within the open program and drag the computer mouse to the destination folder for the file and can save the file at the destination. This new method is more convenient and efficient for a computer user to save open files when a destination is open in a window on their computer screen.

In addition to saving an edited version of a file, a system can present a second action icon associated with the open file, such that the action icon is associated with saving a first version of the open file at the destination and the second action icon is associated with saving a second version of the open file at the destination. The first version can be an unedited version of the open file and the second version of the open file can be an edited version of the open file. The system can convert the file from a first file type to a second file type and can save the open file in the second file type at the destination. Examples of file types are text files, image files and spreadsheet files. For example, the system can present an icon such that a file is converted from a text document to a portable document format (PDF) file and can save the PDF file at the destination. In another example, the system can present an icon such that a file is converted from an image JPEG file format to a PDF file format. In addition to changing the file type, the system can receive a second indication by the user to change a file name of the open file and can change the file name of the open file at the destination. A user can opt to save only a portion of an open file, such as two pages of the file instead of the complete file.

The destination can be an open folder on a graphical display, a desktop of the graphical display, an open email and a post on a social networking application. The destination can be one of a local storage drive such as a hard drive or can be a network storage drive. For example, Bob can have open on his desktop an email application and can open a received email containing an attachment for editing. The attachment opens in a text editing application and Bob edits the attachment. Bob can click on an icon within the text editing application and can drag the mouse to the destination on the graphical display. In this case, the destination is an open email. The edited attachment is saved in the open email that Bob is drafting back to Alice. Then Bob can send the email containing the edited attachment without having to navigate to a folder on his desktop, save the file, then navigate to the folder a second time during the file attachment process within his email program. This new process increases the efficiency of file saving and avoids unnecessary steps in file saving.

These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

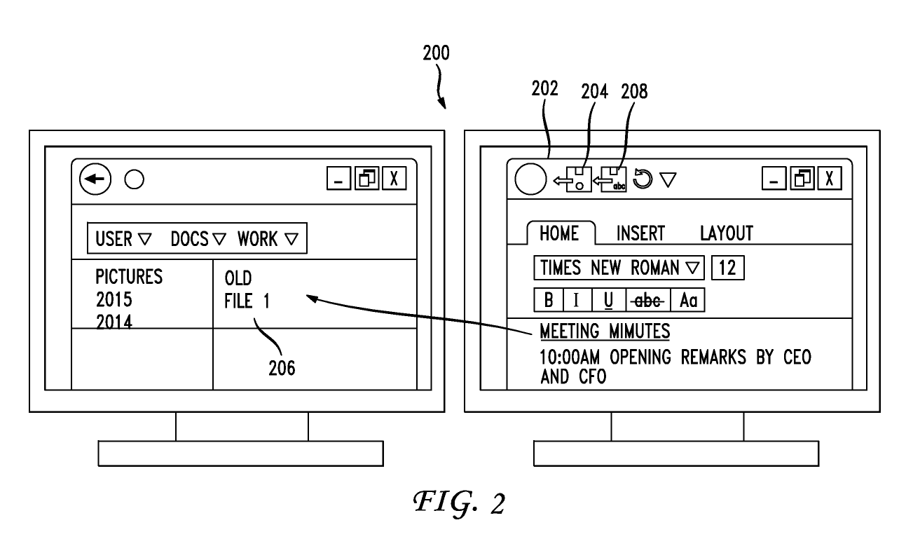

Having disclosed some components of a computing system, the disclosure now turns to FIG. 2, which illustrates a graphical display including an action icon for file saving using a drag and drop method. A user can open a file 202 on a graphical display 200 using a text editing program or another program such as a spreadsheet or image processing program. The system 100 can present an action icon 204 selectable by the user such that the system can receive a dragging indication by the user resulting in a destination 206 for the file identifiable on the graphical display 200. The dragging indication can simply be the user moving the mouse to the destination on the graphical display and clicking again to indicate the destination. The mouse could turn into a hand after clicking on the action icon and the user can grab the open file and drag it to the destination on the graphical display, indicated by unclicking the mouse. In one example, the system can present a second action icon 208 associated with the open file. The action icon 204 is associated with saving a first version of the open file at the destination and the second action icon 208 is associated with saving a second version of the open file at the destination. The first version can be an unedited version of the open file and the second version of the open file can be an edited version of the open file. In this way, a user can save both the unedited and edited versions of a file easily.

For example, Bob can open an email attachment 202 sent to him by Alice using a text editing program. Bob can edit the text and can click on an action icon 204 that saves the unedited version of the open file to the destination 206. Bob can click on a second action icon 208 that saves the edited version of the open file to the destination 206. Bob quickly and efficiently has saved both versions of the document without the time consuming process of navigating to the folder that is open on his desktop.

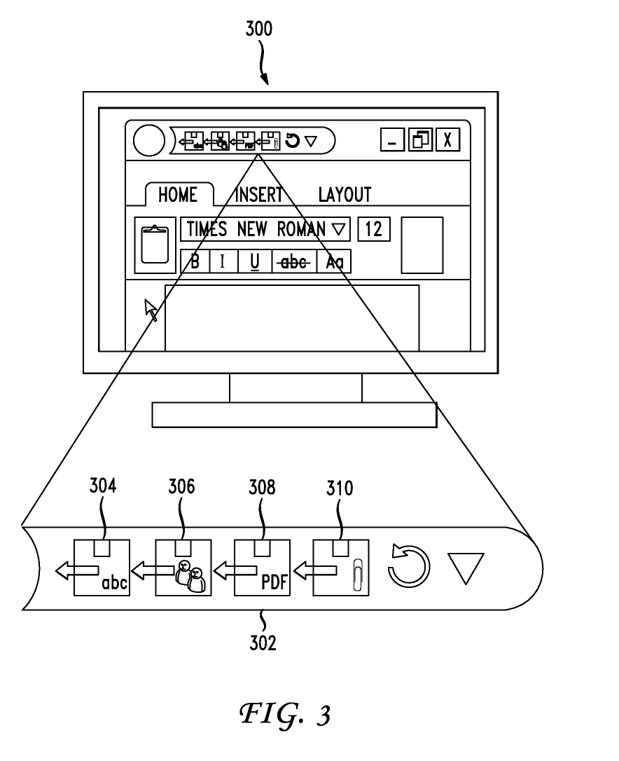

FIG. 3 illustrates a customizable icon grouping for file saving using a drag and drop method within a computer program. A computer program 300 displayed on a graphical display can include a customizable icon grouping 302 such that a user can customize the grouping of icons for file saving that are displayed. A user can opt to include file saving options that they use often to avoid using drop-down menus within the program. For example, an icon for saving an edited version of an open file using a drag and drop method is displayed 304, an icon for saving an open file to a social media post 306 is displayed, an icon for converting the open file to a PDF file format and saving is displayed 308 and an icon for saving an open file as an open email attachment is displayed. These icons represent methods of saving an open file within the program to a destination already open on a graphical display using a drag and drop method. The icon representing saving to a social media post 306 enables a user to have open in a window on their desktop computer a social networking application such as Facebook or Twitter, for example and enables the user to save the open file as a social media post using a drag and drop method instead of using the traditional method. The traditional method would include a user saving the open file by navigating to a destination using a dialog box from within the open computer program. Then, the user would post to the social networking application by clicking on a button within the application to bring up a dialog box for the user to navigate to the saved file. The new method described herein allows the user to avoid the unnecessary steps of opening, navigating and closing dialog boxes within applications to perform the desired task of saving to a location that is already open on a user's desktop. The user can simply activate an icon within the program they are using and indicate the open destination on the display.

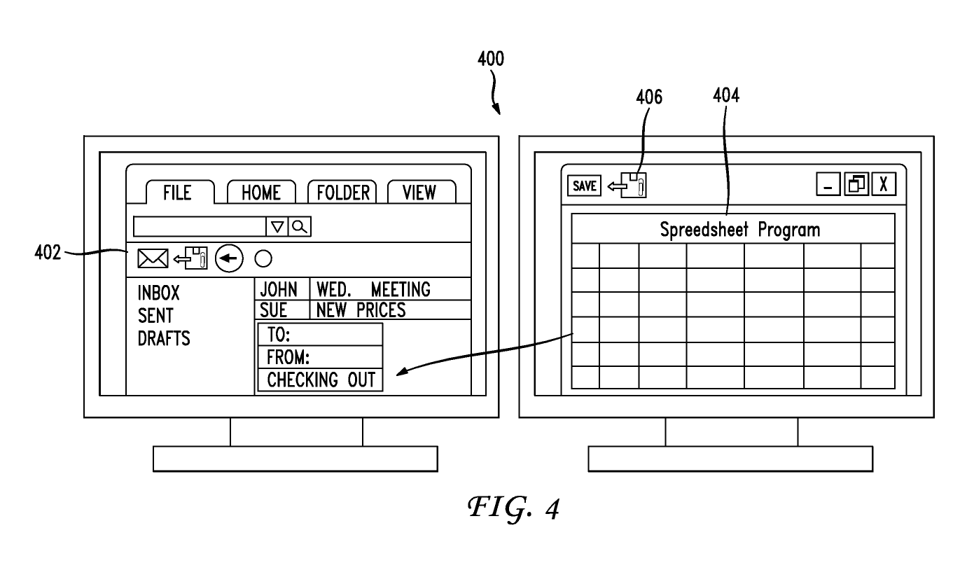

FIG. 4 illustrates a screenshot of an open email application 402 and a spreadsheet program 404 on a graphical display 400. A computer user can use a spreadsheet program for editing and can select an action icon 406 indicating that the open file in the spreadsheet program will be saved as an email attachment. The user can drag the open spreadsheet to their open email application 402 and can indicate the destination as an open email. The email application can attach the open spreadsheet to the email being composed. In another example, a user can save different versions of a spreadsheet as different email attachments. A user can save a current open spreadsheet as an attachment to an open email and then can send the email with the attachment to a desired recipient. The user can then make further edits to the open spreadsheet file. The user can open a second email and can save the edited spreadsheet to the second email and can send to the same or a different recipient, for example. This method allows a user to save an open spreadsheet as an attachment to an email without navigating to a desired location using a dialog box.

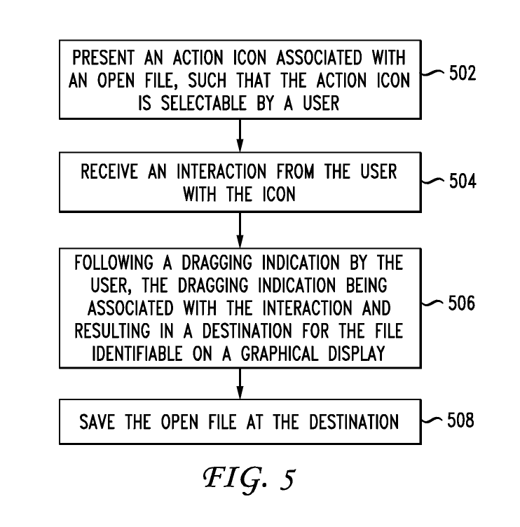

Having disclosed some basic system components and concepts, the disclosure now turns to the exemplary method embodiment shown in FIG. 5. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

FIG. 5 illustrates an example file saving method embodiment. A system 100 can present an action icon associated with an open file, such that the action icon is selectable by a user (502). The system can receive an interaction from the user with the icon (504) such as by a computer mouse click or the tap of a touch screen with a finger. Following a dragging indication by the user, the dragging indication being associated with the interaction and resulting in a destination for the file identifiable on a graphical display (506), the system can save the open file at the destination (508).

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply to file saving of any file format using a drag and drop method to a destination. Those skilled in the art will readily recognize various modifications and changes that may be made to the principles described herein without following the example embodiments and applications illustrated and described herein, and without departing from the spirit and scope of the disclosure.

We claim:

1. A method comprising:
presenting an action icon associated with an open file, wherein the action icon is selectable by a user;
receiving an interaction from the user with the icon;
following a dragging indication by the user, the dragging indication being associated with the interaction and resulting in a destination for the file identifiable on a graphical display; and
saving the open file at the destination.

2. The method of claim 1, further comprising:
converting the file from a first file type to a second file type; and
saving the open file in the second file type at the destination.

3. The method of claim 1, further comprising:
receiving a second indication by the user to change a file name of the open file; and
changing the file name of the open file at the destination.

4. The method of claim 1, wherein the destination is one of a local storage drive and a network storage drive.

5. The method of claim 4, wherein the destination is one of an open folder on the graphical display, a desktop of the graphical display, an open email and a post on a social networking application.

6. The method of claim 1, further comprising saving at least a portion of the open file at the destination.

7. The method of claim 1, wherein the indication is one of a mouse click and a screen tap.

8. The method of claim 1, wherein the file is one of a text file type, an image file type, and a spreadsheet file type.

9. The method of claim 1, further comprising presenting a second action icon associated with the open file, wherein the action icon is associated with saving a first version of the open file at the destination and the second action icon is associated with saving a second version of the open file at the destination.

10. The method of claim 9, wherein the first version is an unedited version of the open file and the second version of the open file is an edited version of the open file.

11. A system comprising:
a processor; and
a computer-readable storage medium storing instructions which, when executed by
the processor, cause the processor to perform a method comprising:
presenting an action icon associated with an open file, wherein the action icon is selectable by a user;
receiving an interaction from the user with the icon;
following a dragging indication by the user, the dragging indication being associated with the interaction and resulting in a destination for the file identifiable on a graphical display; and
saving the open file at the destination.

12. The system of claim 11, further comprising:
converting the file from a first file type to a second file type; and
saving the open file in the second file type at the destination.

13. The system of claim 11, further comprising:
receiving a second indication by the user to change a file name of the open file; and
changing the file name of the open file at the destination.

14. The system of claim 11, further comprising:
presenting a second action icon associated with the open file, wherein the action icon is associated with saving a first version of the open file at the destination and the second action icon is associated with saving a second version of the open file at the destination.

15. The system of claim 14, wherein the first version is an unedited version of the open file and the second version of the open file is an edited version of the open file.

16. The system of claim 11, wherein the indication is one of a mouse click and a screen tap.

17. A computer-readable storage medium having instructions stored which, when executed by a computing device, cause the computing device to perform a method comprising:
presenting an action icon associated with an open file, wherein the action icon is selectable by a user;
receiving an interaction from the user with the icon;
following a dragging indication by the user, the dragging indication being associated with the interaction and resulting in a destination for the file identifiable on a graphical display; and
saving the open file at the destination.

18. The computer-readable storage medium of claim 17, wherein the destination is one of an open folder on the graphical display, a desktop of the graphical display, an open email and a post on a social networking application.

19. The computer-readable storage medium of claim 17, further comprising:
presenting a second action icon associated with the open file, wherein the action icon is associated with saving a first version of the open file at the destination and the second action icon is associated with saving a second version of the open file at the destination.

20. The computer-readable storage medium of claim 19, wherein the first version is an unedited version of the open file and the second version of the open file is an edited version of the open file.
